(19) United States
(12) Patent Application Publication
(10) Pub. No.: US 2003/0098025 A1
(43) Pub. Date: May 29, 2003

(54) MASKAP

(76) Inventor: Joseph Henry Bigelow, Upton, MA (US)

Correspondence Address: KEVIN S. LEMACK, NIELDS & LEMACK, 176 E. MAIN ST., WESTBORO, MA, 01581, US

(21) Appl. No.: 09/974,604

(22) Filed: Nov. 27, 2001

(51) Int. Cl. A62B 18/08

(52) U.S. Cl. 128/206.17

(57) ABSTRACT

The maskap is a safety mask that is worn like a cap. The cap has a thin rubber liner (or airtight material) that will cover the inside of the cap. The rubber liner will form a seal when worn as a mask. There are two plastic eye covers that are sealed to the cap, that when worn as a mask will let the user see through them. On the brim of the cap but under the fabric is a filter box. The filter box will hold a filter for the use needed or an all-purpose filter. The filter box will have two air tubes molded to it. The air tubes will run up the front of the cap. Then the open end of the air tubes will be sealed with the rubber liner. When the maskap is worn as a mask the user will breath through the filter box. There will be a cross section of elastic bands that are sewn to the cap at three or more points. The elastic bands will be held inside the cap until needed, to hold the maskap on. When worn as a mask the user will pull out the elastic bands. Pull maskap over face and elastic bands behind the head.

### FIELD OF THE INVENTION

This invention relates to a safety mask that is in the form of a cap. The cap is a mask when pulled down over the face, the user would have a quick way to protect their eyes and themselves from breathing dust, gases, smoke and germs. It would be basically for emergencies or short time use. The user would not have to carry a gas mask with them all they have to do is wear the maskap as a cap. The safety of having a mask to protect users would become more of a part of life.

### SUMMARY OF THE INVENTION

This invention is a safety mask that is worn as a cap. When worn as a mask it protects the eyes from smoke, dust, gases or most other foreign particles. It also protects from breathing smoke, dust, gases or most other foreign particles. The words smoke, dust, gases and foreign particles are used broadly to describe many types of each. The cap is comprised of a filter on the brim of the cap. It has air tubes running up the front of the cap that are sealed with the thin inner rubber liner (or an airtight material) of the cap. The thin inner rubber liner is to form a good seal with the users face. The plastic eye covers would be sealed to the liner as well. The plastic eye covers are cutouts in the cap that provide vision when in use and possibly made from fog proof plastic. The cap is worn like a hat. The mask is held on with elastic straps to be pulled out of the cap by user and pulled over the back of the head as the mask is pulled over the face from top of forehead to under chin. There is an elastic band on the back of the cap to provide some adjustment of size.

Due to the tragedy of Sep. 11, 2001 it is a good idea to have something readily available that you could wear that you could pull over your face real quick in an emergency situation. This cap would cover your eyes and mouth and filter the air you breathe. You could wear the cap for years without using it; but if you needed something real quick, you could use the MASKAP. There will probably be some simple testing of design before manufacturing. I did a simple patent search and could not find anything close with these features. This is not a typical dust/gas mask, it is discreet and very handy in an emergency as it covers the whole face.

### BREIF DESCRIPTION OF DRAWINGS

### Drawings: 3

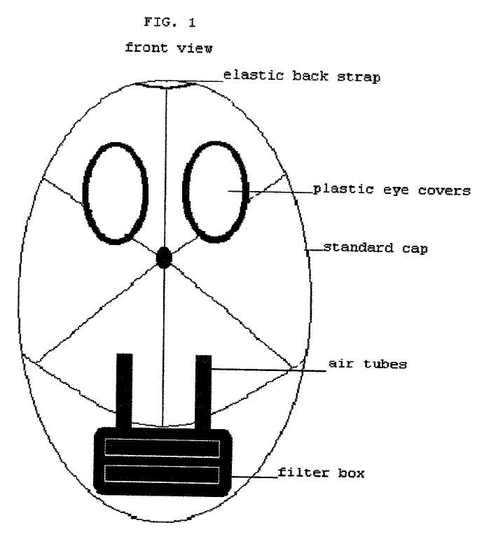

FIG. 1 Front view as a mask/top view as a cap

Shows sealed plastic eye covers, filter box and air tubs.

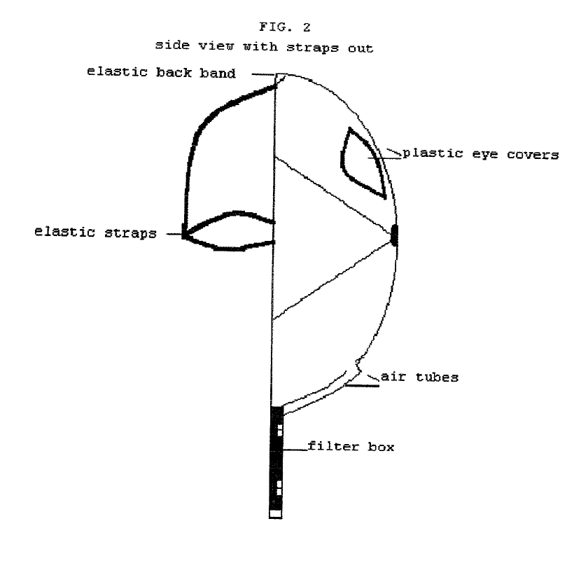

FIG.2 Side view

Shows elastic bands out as if worn as a mask.

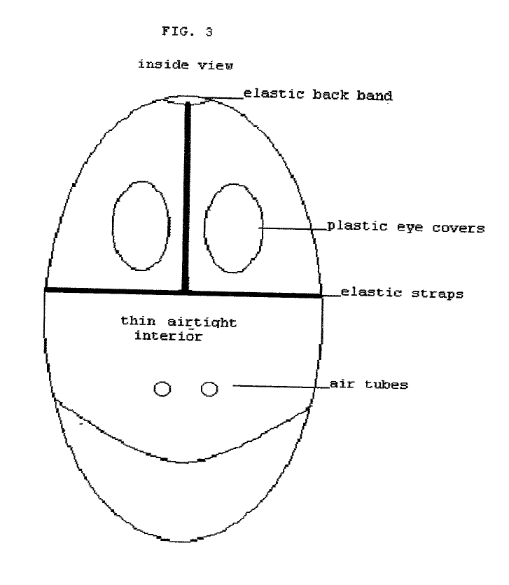

FIG.3 Inside view

Shows air tubes open end with edges sealed with rubber liner.

Shows airtight liner.

Shows elastic bands.

### DESCRIPTION OF THE INVENTION

This description represents a maskap.

The front view as a mask or a top view as a cap is shown in FIG. 1

It shows a standard baseball like cap. Shown in FIG. 2 & 3. The cap has an elastic back band to allow for some size adjustment.

To allow the user to see when this invention is worn as a mask there are two see thru plastic eye covers sealed into the cap.

FIG. 1. Shows a filter box and air tubes running from the filter box up the front of the cap. The filter box is to house a filter and the air tubes are to allow air to flow from outside the mask. The air tubes are sealed inside the mask to the thin rubber liner (or airtight material) shown in FIG. 3. the inside view.

FIG. 2. Shows a side view of the same invention with the elastic straps out as if being worn as a mask. The elastic straps would be inside the cap when worn as a cap to conform to the shape of the inside of the cap.

FIG. 3. Shows the whole mask from inside with the thin rubber liner cover, except cut outs for the eye covers and the inlets for the air tubes. The rubber liner is to form a seal between the users face and the outside. The main advantage of this invention is that it covers most, if not all, of the users face including eyes, nose and mouth. It also, if worn as a cap, is very quick and handy in a emergency that might include smoke, dust, gases and even some germs. It also could be carried in a pocket, bag or car. It does not have to be worn as a cap.

What I claim as my invention is:

1. An item that can be worn as a cap and can be quickly pulled over the whole face and worn as a safety mask.

2. The item from 1 lets user see and breathe through the mask by way of plastic eye covers and a self-contained filter system.

3. The item from 2 self-contained filter system will be made to filter gases, smoke, dust and germs or it will be labeled to what the filter is to be used for.

4.The item from 1 is held to the face in the mask position by elastic straps.

5. The item from 1 is lined with airtight material to form seal with users face.
